(19) United States
(12) Patent Application Publication
(10) Pub. No.: US 2002/0017966 A1
(43) Pub. Date: Feb. 14, 2002

(54) Arrangement for connecting two identical electromagnetic wave guides

(75) Inventor: Udo Seewig, Langenhagen (DE)

Correspondence Address: SUGHRUE, MION, ZINN, MACPEAK & SEAS, PLLC, 2100 Pennsylvania Avenue, NW, Washington, DC, 20037-3213, US

(73) Assignee: ALCATEL

(21) Appl. No.: 09/918,507

(22) Filed: Aug. 1, 2001

(30) Foreign Application Priority Data
Aug. 2, 2000 (DE) 100 37 554.5

(51) Int. Cl. H01P 1/165

(52) U.S. Cl. 333/21 A; 333/34; 333/254

(57) ABSTRACT

An arrangement is disclosed for connecting two identical electromagnetic wave guides with rectangular cross-section, which serve to transmit linearly polarised electromagnetic waves and the rectangular hollow spaces of which are twisted with respect to one another in such a way that their corresponding axes run at right angles to one another. Between the two wave guides a connecting element is arranged, by means of which a low-reflection rotation of the polarisation plane of the waves to be transmitted takes place from the polarisation plane of one wave guide into the polarisation plane of the other wave guide orthogonal thereto.

### DESCRIPTION

The invention is based on a priority application (DE 100 37 554.5) which is hereby incorporated by reference.

The invention relates to an arrangement for connecting two identical electromagnetic wave guides with rectangular cross-section, which serve to transmit linearly polarised electromagnetic waves and the rectangular hollow spaces of which are twisted with respect to one another in such a way that their corresponding axes run at right angles to one another, in which a connecting element is arranged between the two wave guides, by means of which a low-reflection rotation of the polarisation plane of the waves to be transmitted takes place from the polarisation plane of one wave guide into the polarisation plane of the other wave guide orthogonal thereto (DE-C-3 733 397).

An arrangement of this kind is required, for example, if a wave guide is to be connected to another wave guide or to a device with a wave guide connection and if the axes of the respective terminals are located in planes running at right angles to one another. A possible field of application would be, for example, with antennae with a parabolic reflector and a supply line formed by a rectangular wave guide. A transmitting wave guide, which produces the connection to a transmit-receive system, is connected to the supply line mounted on the reflector. Between the supply line and the transmitting wave guide a device can be inserted, which, for example, contains mixers or other electronic components. The polarisation planes in which the electromagnetic waves to be transmitted oscillate are fixed by the rectangular wave guide of the supply line on the one hand and the transmitting wave guide or the inserted device on the other hand. As these two polarisation planes run orthogonal to one another, the transition components used must enable as low-loss a commutation as possible of the waves between the supply line and the wave guide or device to be connected thereto.

A transition component of this kind emerges from DE-C-3 733 397, mentioned above. The transition component, designated as a wave guide twist, consists, for example, of three wave guide sections which are connected to one another as twistable with respect to one another about their longitudinal axis. The wave guide twist can thereby be set at different angles between the axes of the clear openings at both its ends. A lever running in the longitudinal direction of the wave guide twist is rotatably mounted on the outside of the central wave guide section. At both ends of the lever pins stick out which engage in guide grooves mounted on the outside of the other two wave guide sections, running in the longitudinal direction of the wave guide twist. Construction of this known wave guide twist is expensive. It also has too large an axial length for arrangements with limited space.

### SUMMARY OF THE INVENTION

The object of the invention is to structure the arrangement described above as simpler and shorter.

This object is achieved according to the invention in that

the connecting element is constructed as a wave guide section with rectangular cross-section, the axes of which determining the position of its rectangular hollow space run at an angle of 45° in each case with respect to the corresponding axes of the two wave guides to be connected,

the hollow space of the wave guide section is narrowed in the central region of its long sides by two projections located diametrically opposite one another and projecting into the hollow space and

the axial width of the wave guide section corresponds to approximately a quarter of the wavelength of the average frequency of the waves to be transmitted.

This arrangement consists of a single part, namely the wave guide section. It is therefore very simply constructed and equally simple to assemble. Of particular significance is the very small length of the wave guide section in the axial direction, which is determined only by the average frequency of the waves to be transmitted. The arrangement can therefore advantageously be used where there is only a very small distance available between the wave guides to be connected. Although only one step is used with the wave guide section for rotation of the polarisation plane of the electromagnetic waves, this arrangement has a very favourable reflection factor with correspondingly low electrical losses. This considerable advantage is ensured by the narrowing of the hollow space of the wave guide section in its central region with the two projections located opposite one another.

Advantageous configurations of the invention emerge from the subordinate claims.

### BRIEF DESCRIPTION OF THE DRAWINGS

An embodiment example of the subject of the invention is illustrated in the drawings.

FIG. 1 shows in schematic representation an antenna arrangement with an arrangement according to the invention.

FIGS. 2 and 3 show details of the arrangement, also in schematic, enlarged representations.

FIG. 4 shows the wave guide section inserted in the arrangement in a further enlarged representation.

FIG. 5 shows a section through FIG. 4 along the line V-V.

The invention is described below for use of the arrangement on an antenna with a parabolic reflector. This does not, however, represent any limitation of the general applicability of the arrangement for connecting two rectangular wave guides.

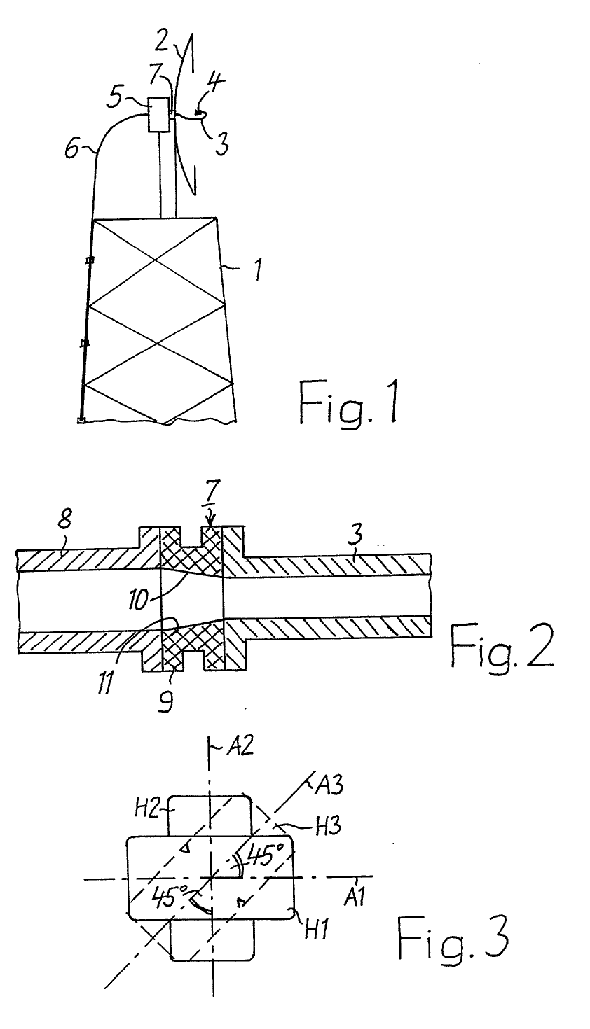

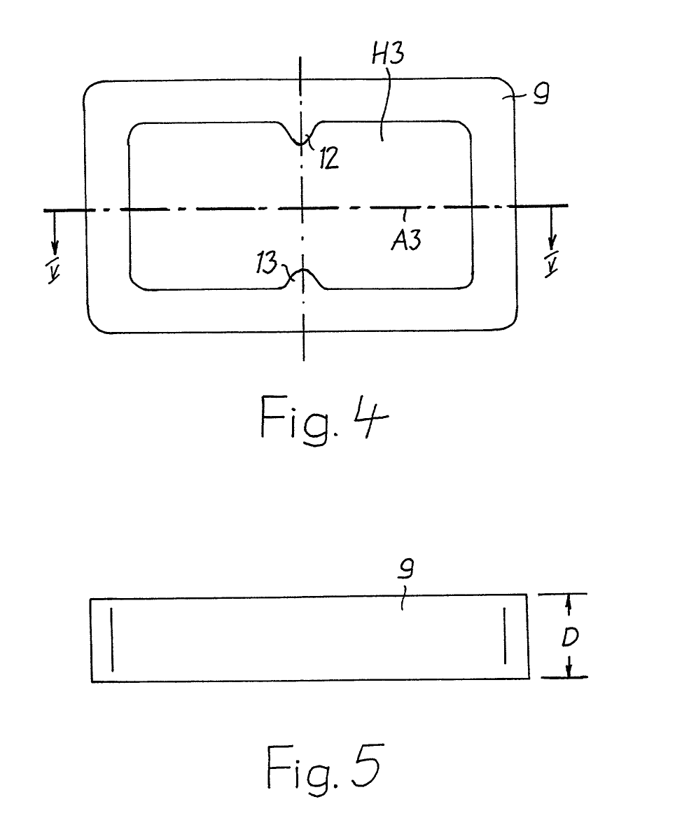

In FIG. 1 the tip of a mast 1 is indicated schematically, on which a parabolic reflector 2 of an antenna is mounted. On the reflector 2 is mounted a supply line 3 constructed as a rectangular wave guide, to the open end of which an exciter 4 serving to illuminate the antenna is attached. On the side of the reflector 2 facing away from the supply line 3 a device 5 is mounted on the mast 1, to which a wave guide 6 is connected, which is connected to a transmit-receive device, not illustrated. Between the device 5 and the supply line 3 an arrangement 7, acting as connection, is attached, the more precise structure of which emerges from FIG. 4.

FIG. 2 reproduces in a schematic representation the connecting point between the wave guide input 8 of the device 5 and the supply line 3. The arrangement 7, constructed as a wave guide section 9, is mounted between the two parts in such a way that a low-reflection transition from one polarisation plane into the one orthogonal thereto takes place for the electromagnetic waves to be transmitted. This is indicated by two diagonal lines 10 and 11.

The location of the rectangular hollow spaces H1 and H2 of the wave guides to be connected and H3 of the wave guide section 9 relative to one another emerges from FIG. 3. The large axes A1, A2 and A3 of the hollow spaces H1, H2 and H3 as corresponding axes are therein also drawn in. The other corresponding axes are the small axes. They are not illustrated for the sake of simplicity. The hollow space H1 with the axis A1 belongs to the supply line 3. The hollow space H2, offset therefrom by 90°, with the axis A2, is the hollow space of the wave guide input 8. The hollow space H3 of the wave guide section 9 with the axis A3 is arranged in such a way that the axis A3 encompasses an angle of 45° with both the axis A1 and with the axis A2.

The wave guide section 9 has a rectangular hollow space H3, which according to FIG. 4 is narrowed in the central region. Projections 12 and 13, located diametrically opposite one another, which project into the hollow space H3, are provided for this purpose in the centre of the long sides of the hollow space H3. In a preferred embodiment their ends are rounded. The projections 12

and 13 can, however, have any chosen geometric shape. As well as the round shape they can, for example, also be rectangular, triangular or mushroom-shaped. In a preferred embodiment the corners of the hollow space H3 are rounded.

The wave guide section 9 has a thickness D, corresponding to approximately a quarter of the average frequency of the frequency band used for transmission of the electromagnetic waves. With an average frequency of, for example, 12,975 GHz in the frequency band 12.7 to 13.25 GHz, the so-called 12 GHz band, a thickness D and therefore an axial length for the wave guide section of 7.2 mm results. The wave guide wavelength allocated to the frequency band is around 29 mm.

The short sides of the hollow space H3 of the wave guide section 9 are preferably slightly longer than the short sides of the hollow spaces H1 and H2 of the two wave guides, by an amount of less than 5%. If the short sides of the hollow spaces H1 and H2 are, for example, 30 mm long, the short sides of the hollow space H3 can be, for example, 0.9 mm longer. This corresponds to a lengthening of 3%. When the arrangement 7 is used to transmit the 12 GHz band, the projections 12 and 13 project, for example, in each case by 0.9 mm into the hollow space H3 of the wave guide section 9. This is approximately 3% of the wave guide wavelength. They can be rounded at their tip with a corresponding radius of 0.9 mm. On both sides the projections 12 and 13 can in each case verge into the long edge of the hollow space H3 of the wave guide section 9 with a radius of approximately 1.5 mm.

1. Arrangement for connecting two identical electromagnetic wave guides with rectangular cross-section, which serve to transmit linearly polarised electromagnetic waves and the rectangular hollow spaces of which are twisted with respect to one another in such a way that their corresponding axes run at right angles to one another, in which a connecting element is arranged between the two wave guides, by means of which a low-reflection rotation of the polarisation plane of the waves to be transmitted takes place from the polarisation plane of one wave guide into the polarisation plane of the other wave guide orthogonal thereto,
constructing the connecting element as a wave guide section with rectangular cross-section, the axes of which determining the position of its rectangular hollow space run at an angle of 45° in each case with respect to the corresponding axes of the two wave guides to be connected
narrowing the hollow space of the wave guide section in the central region of its long sides by two projections located diametrically opposite one another and projecting into the hollow space and
making the axial width of the wave guide section corresponding to approximately a quarter of the wavelength of the average frequency of the waves to be transmitted.

2. Arrangement according to claim 1, wherein the short sides of the hollow space of the wave guide section are slightly longer than the short sides of the hollow spaces of the two wave guides to be connected.

3. Arrangement according to claim 1, wherein the short sides of the hollow space of the wave guide section are less than 5% longer than the corresponding sides of the two wave guides.

4. Arrangement according to one of claims 1, wherein the projections in the hollow space of the wave guide section are rounded at their ends pointing into the hollow space.

5. Arrangement according to one of claims 1, wherein the corners of the hollow space of the wave guide section are rounded.
